(19) United States
(12) Patent Application Publication
(10) Pub. No.: US 2005/0132387 A1
(43) Pub. Date: Jun. 16, 2005

(54) Electronic apparatus and optical disk recording/reading device including circuit board

(75) Inventors: Tatsuo Katayama, Takefu-city (JP); Yasuhisa Ueda, Takefu-city (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: ORION ELECTRIC CO., LTD., Takefu-city (JP)

(21) Appl. No.: 11/006,761

(22) Filed: Dec. 8, 2004

(30) Foreign Application Priority Data
Dec. 12, 2003 (JP) 2003-414953

(51) Int. Cl. G11B 33/02

(52) U.S. Cl. 720/600

(57) ABSTRACT

The invention provides an electronic apparatus to which a circuit board is attached so that noise caused by a drive unit can be prevented. The electronic apparatus includes a drive unit 2 and a circuit board 5 mounted with electronic components 4 for controlling the drive unit 2. Conductive circuit patterns are formed on both sides of the circuit board 5, and the electronic components 4 are mounted only on one surface of the circuit board 5. The circuit board 5 is attached to the electronic apparatus with anon-mounting surface thereof faced to the drive unit 2, whereby noise caused by the drive unit 2 is blocked by the circuit board 5. Consequently, it is possible to reduce noise of the drive unit 2 from affecting the electronic components 4 mounted on the circuit board 5. In addition, since the non-mounting surface of the circuit board 5 is faced to the drive unit 2 side, the freedom of design on the device side is improved.

The present application is based on and claims priority of Japanese patent applications No. 2003-414953 filed on Dec. 12, 2003, the entire contents of which are hereby incorporated by reference.

### BACKGROUND OF THE INVENTION

1. Field of the Invention

The present invention relates to an electronic apparatus to which a circuit board, only on one surface of which components are mounted, is attached with a component non-mounting surface to a unit side. In particular, the invention relates to an electronic apparatus and an optical disk recording/reading device including a circuit board to which a circuit board, only on one surface of which components are mounted and on the other surface of which a pattern is wired, is attached with the pattern wired surface to a unit side, so as to prevent the noise generated from a drive unit.

2. Description of the Related Art

Conventionally, a circuit board for controlling an electronic apparatus is assembled in the electronic apparatus. Such circuit board often remains in a state in which a surface thereof is provided with a resist treatment or a state of an insulating plate. Usually, in this state, a surface of a printed board is colored, for example, in green. Various electronic components such as a resistor, a transistor, and an integrated circuit are mounted on the printed board. Japanese Utility Model Laid-Open Publication No. 6-11372 discloses a heat radiation printed board in which a heat radiation pattern of a copper foil is printed on a board provided with a soldering portion, in which terminals for cooling are provided in IC mounted components such as an integrated circuit to be soldered to the printed board, and in which a black heat radiation layer is formed on this heat radiation pattern by means such as silk printing.

In such circuit board, a technique for mounting components on both sides of the circuit board is widely implemented. Japanese Patent Laid-Open Publication No. 2003-168852 discloses a technique for arranging memory elements three-dimensionally. Japanese Patent Laid-Open Publication No. 2003-115647 discloses a technique for arranging a base model circuit on one surface of a circuit board and arranging an option circuit on the other surface of the circuit board.

Incidentally, in an optical disk reading device that reads videos and sounds recorded in an optical disk such as a Digital Versatile Disc (DVD) or a Compact Disc (CD), in general, an optical disk is rotated by a turn table, and information such as videos or sounds stored in a track of the optical disk is read while a pickup for reading the information recorded in the optical disk is moved in a radial direction of the optical disk.

In this type of an optical disk reading device, driving noise caused when the pickup is moved in the radial direction of the optical disk or when the optical disk is rotated affect a digital processing integrated circuit mounted on a circuit board. Consequently, in the optical disk reading device, it is extremely important to take not only heat measures against the heat generated from the electronic components described above but also measures against noise.

### SUMMARY OF THE INVENTION

The invention has been devised in view of the problems described above, and it aims at providing an electronic apparatus to which a circuit board is attached so that the influence of noise caused by a drive unit can be prevented. Moreover, the invention also aims at providing an electronic apparatus in which a heat radiation effect is improved.

An electronic apparatus in accordance with a first aspect of the invention is an electronic apparatus including a drive unit, comprising a circuit board mounted with various electronic components for controlling the drive unit, wherein the various electronic components are mounted only on one surface of the circuit board, and a conductive circuit pattern is formed on the other surface of the circuit board having no electronic components mounted thereon, and wherein the circuit board is attached to the electronic apparatus with the non-mounting surface of the circuit board faced to the drive unit side.

According to the arrangement of the first aspect of the invention, since the mounting side of the circuit board is located on a side opposite to the drive unit, noise generated from the drive unit is blocked by the circuit board. Thus, it is possible to prevent the noise from the drive unit from affecting the electronic components mounted on the circuit board and improve the freedom of design of the apparatus side without being affected by the electronic components on the circuit board.

An electronic apparatus including a circuit board in accordance with a second aspect of the invention is an electronic apparatus including a circuit board in accordance with the first aspect of the invention, wherein a black heat radiation layer is formed by silk printing on the non-mounting surface of the circuit board.

According to the arrangement of the second aspect of the invention, since the black heat radiation layer is provided on the circuit board, a cooling effect for mounted components is improved by the heat radiation effect of the black heat radiation layer.

According to the third aspect of the invention, an optical disk recording/reading device including an optical disk drive unit comprises a circuit board mounted with various electronic components for controlling the optical disk drive unit, wherein various electronic components are mounted only on one surface of the circuit board, and a conductive circuit pattern is formed on the other surface of the circuit board having no electronic components mounted thereon, and wherein the circuit board is attached to the optical disk recording/reading device with the circuit pattern formed surface of the circuit board faced to the optical disc drive unit side.

According to the arrangement of the third aspect of the invention, with the circuit board itself, a digital processing integrated circuit mounted on the circuit board can prevent driving noise received when the pickup of the optical disk recording/reading device moves in a radial direction of the optical disk or when the optical disk is rotated from affecting the digital processing integrated circuit. Thus, it is possible to improve the freedom of design on the optical disk recording/reading device side without being affected by the electronic components on the circuit board.

### BRIEF DESCRIPTION OF THE DRAWINGS

FIG. 1 is a front view of an optical disk reading device of the invention;

FIG. 2 is a front view showing a modification of the optical disk reading device of the invention; and

FIG. 3 is a front view showing a non-mounting surface of components on a circuit board attached to the optical disk reading device of the invention.

### DETAILED DESCRIPTION OF THE PREFERRED EMBODIMENTS

Now, the present invention will be described according to the preferred embodiment. Please note that the following embodiment is a mere example for embodying the invention and is not intended to limit the invention within the scopes of the embodiment.

In addition, since the invention is not directed to what kind of means are specifically used to attach a circuit board to an electronic apparatus, the attaching means are not shown in the figures. However, the attachment of the circuit board can be appropriately designed by those skilled in the art with the conventional method.

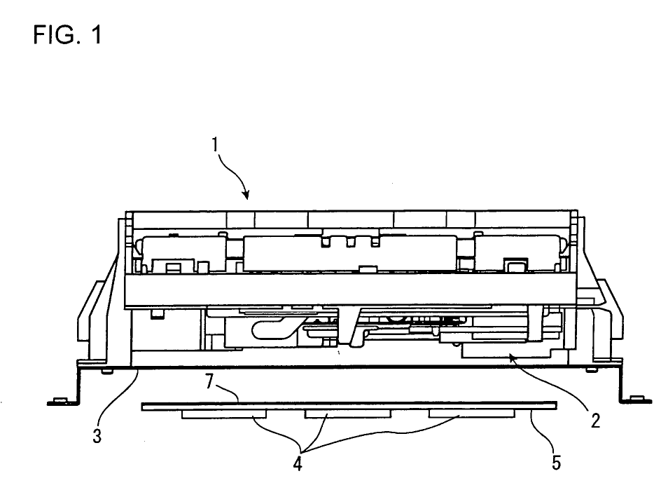

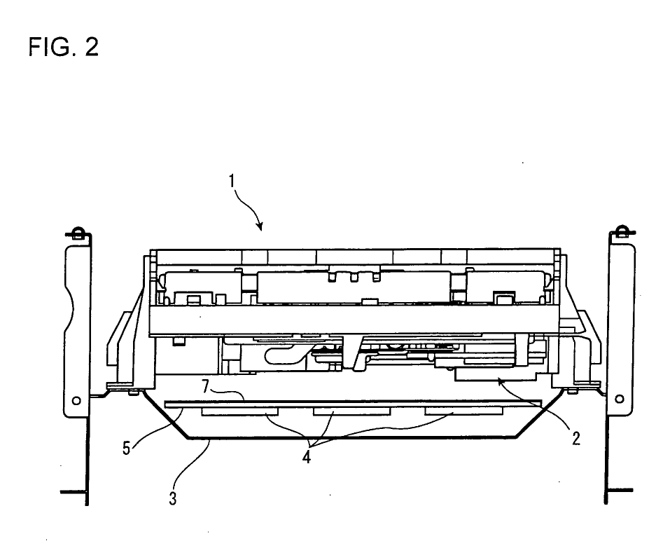

FIG. 1 is a front view of an optical disk reading device according to the invention. A drive unit 2 of the optical disk reading device 1 includes, as main components, a turn table that rotates an optical disk, a pickup that reads videos and sounds stored in the optical disk, and a moving unit that moves the pickup in a radial direction of the optical disk and such. A shield plate 3 is fixed below the drive unit 2, and a circuit board 5 mounted with electronic components 4 such as an integrated circuit for controlling the optical disk reading device 1 is provided below the shield plate 3 in parallel thereto. Note that in FIG. 1, the circuit board 5 is fixed to the drive unit 2 via the shield plate 3. However, as shown in FIG. 2, it is also possible to fix the circuit board 5 directly below the drive unit 2 and fix the shield plate 3 to the drive unit 2 so as to cover the circuit board 5.

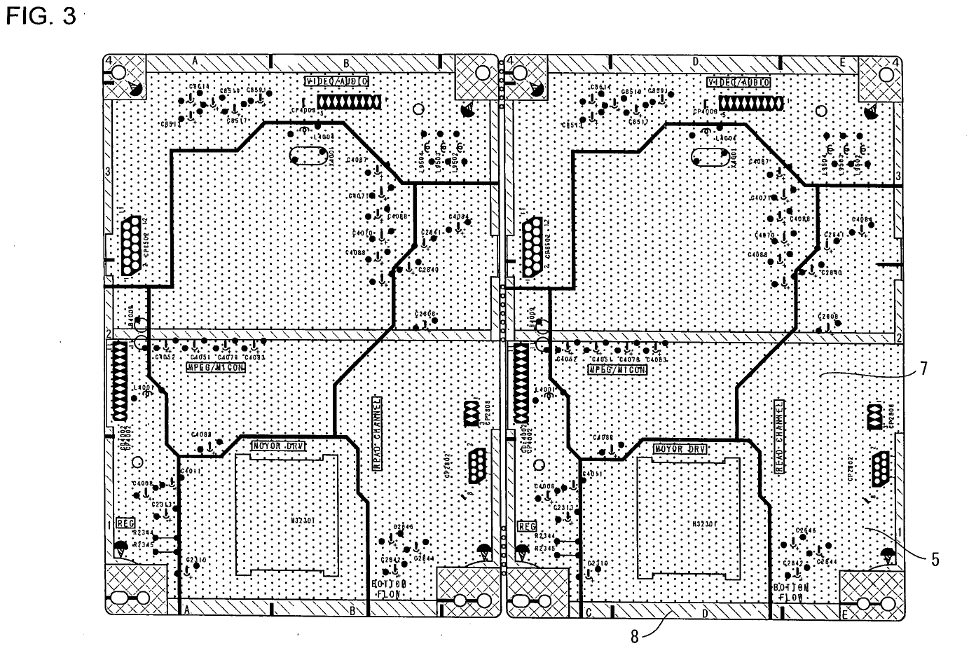

FIG. 3 shows one preferred embodiment of the circuit board 5 used in the invention. Circuit patterns (not shown in the figure) made of a conductive material such as a copper foil are formed on both surfaces of the circuit board by printing. Various electronic components are mounted on one side (a back surface in FIG. 3), and a black heat radiation layer 7 is provided on a non-mounting side (as shown in FIG. 3) of the circuit board so as to cover the circuit pattern. Note that it is possible to form the heat radiation layer 7 where soldering is not placed on a circuit pattern with conventional means such as silk printing by replacing a translucent solder resist, which forms a heat radiation layer such that a circuit pattern of a circuit board can be seen through the heat radiation layer, with a black paint. Note that in FIG. 3, the heat radiation layer 7 is indicated by halftone dots and sections printed on the circuit board as representation of a mechanism part run off, an automatic insertion part prohibited portion for electronic components, a component appearance, a land, and a clinch prohibited portion are indicated by shaded parts 8. The mechanism part run off 8 calls the attention such that a foreign material is not placed thereon by mistake in each work process. In this way, in the circuit board 5, although the circuit patterns are formed on both surfaces by printing, the electronic components are mounted only on one surface side thereof and the circuit board 5 is fixed by an attachment frame (not shown) with the non-mounting surface thereof faced to the drive unit side.

As described above, since the mounting surface of the circuit board 5 is located on a side opposite to the drive unit 2, it is possible to prevent noise from the drive unit 2 from affecting the electronic components 4 mounted on the circuit board 5 as much as possible. In particular, in the optical disk reading device 1, although driving noise received when the pickup moves in the radial direction of the optical disk or when the optical disk is rotated adversely affect the electronic components 4 such as a digital processing integrated circuit mounted on the circuit board 5, it is possible to effectively prevent the noise from the drive unit 2 from affecting the electronic components 4 by locating the mounting surface of the circuit board 5 on the surface opposite to the drive unit 2 and fixing the non-mounting surface of the circuit board 5 to the drive unit 2 side. Further, since the electronic components 4 are not mounted on the drive unit 2 side, it is possible to set a circuit pattern of the circuit board 5 without any restraint and without the necessity of considering a positional relation of the electronic components 4 of the circuit board 5 with respect to the drive unit 2. Thus, the freedom of design of the circuit board 5 is improved.

Moreover, since the black heat radiation layer is formed on the non-mounting surface of the circuit board 5 by silk printing, it is possible to improve a cooling effect for the electronic components 4 mounted on the circuit board 5 by the heat radiation effect of this black heat radiation layer. In addition, since it is possible to judge at one glance whether a surface is a mounting surface or a non-mounting surface, workability and production efficiency are improved.

According to the electronic apparatus in accordance with the first aspect of the invention, the electronic apparatus comprises a circuit board mounted with various electronic components for controlling the drive unit, wherein the various electronic components are mounted only on one surface of the circuit board, and a conductive circuit pattern is formed on the other surface of the circuit board having no electronic components mounted thereon, and wherein the circuit board is attached to the electronic apparatus with the non-mounting surface of the circuit board faced to the drive unit side. This circuit board enables to block and suppress noise from the drive unit. In addition, since it is unnecessary to consider a positional relation between the various electronic components mounted on the circuit board and the drive unit, the freedom of design of the circuit board is improved.

According to the electronic apparatus in accordance with the second aspect of the invention, a black heat radiation layer is formed by silk printing on the non-mounting surface of the circuit board. Thus, it is possible to improve a cooling effect for mounted components with a heat radiation effect of the black heat radiation layer provided on the circuit board. In addition, since it is possible to judge at one glance whether a surface is a mounting surface or a non-mounting surface, workability and production efficiency are improved.

According to the optical disk recording/reading device in accordance with the third aspect of the invention, the optical disk recording/reading device comprises a circuit board mounted with various electronic components for controlling a DVD drive unit, wherein the various electronic components are mounted only on one surface of the circuit board, and a conductive circuit pattern is formed on the other surface of the circuit board having no electronic components mounted thereon, and wherein the circuit board is attached to the optical disk recording/reading device with the circuit pattern formed surface of the circuit board faced to the DVD drive unit side. Thus, in the optical disk recording/reading device, it is possible to prevent driving noise received when the pickup moves in a radial direction of the optical disk or when the optical disc is rotated from affecting the electronic components. In addition, since it is unnecessary to consider a positional relation between the various electronic components mounted on the circuit board and the pickup or the DVD drive unit, the freedom of design of the circuit board is improved.

1. An electronic apparatus including a drive unit, comprising a circuit board mounted with various electronic components for controlling this drive unit, wherein the various electronic components are mounted only on one surface of the circuit board, and a conductive circuit pattern is formed on the other surface of the circuit board having no electronic components mounted thereon, and wherein the circuit board is attached to the electronic apparatus with the non-mounting surface of the circuit board faced to the drive unit side.

2. The electronic apparatus comprising a circuit board according to claim 1, wherein a black heat radiation layer is formed by silk printing on the non-mounting surface of the circuit board.

3. An optical disk recording/reading device including an optical disk drive unit, comprising a circuit board mounted with various electronic components for controlling the optical disk drive unit, wherein the various electronic components are mounted only on one surface of the circuit board, and a conductive circuit pattern is formed on the other surface of the circuit board having no electronic components mounted thereon, and wherein the circuit board is attached to the optical disk recording/reading device with the circuit pattern formed surface of the circuit board faced to the optical disk drive unit side.
